(19) United States
(12) Patent Application Publication
(10) Pub. No.: US 2010/0110348 A1
(43) Pub. Date: May 6, 2010

(54) LIQUID CRYSTAL DISPLAY DEVICE AND METHOD FOR MANUFACTURING THE SAME

(76) Inventor: Shinichi Hirato, Osaka (JP)

Correspondence Address: BIRCH STEWART KOLASCH & BIRCH, PO BOX 747, FALLS CHURCH, VA, 22040-0747, US

(21) Appl. No.: 12/532,505

(22) PCT Filed: Feb. 4, 2008
(86) PCT No.: PCT/JP2008/051748

§ 371 Date: Sep. 22, 2009

(30) Foreign Application Priority Data
Jun. 27, 2007 (JP) 2007-169649

(51) Int. Cl. G02F 1/1335; G02F 1/13; G02F 1/1339

(52) U.S. Cl. 349/106; 349/187; 349/155

(57) ABSTRACT

A liquid crystal display panel (10) provided in the liquid crystal display device of the present invention includes: a color filter substrate (30); a TFT substrate (element substrate) (20); and a liquid crystal layer (40) provided between the color filter substrate (30) and the TFT substrate (20). The liquid crystal layer has a structure in which spacer particles (50) for keeping the gap between the TFT substrate (20) and the color filter substrate (30) are disposed in regions of the liquid crystal layer which correspond to respective non-display regions of the liquid crystal panel (10). In regions of the color filter (30), which regions correspond to the respective non-display regions in which the spacer particles (50) are disposed, colored layers (32a) having a thickness equal to that of colored layers (32a) provided in regions corresponding to respective display regions are provided.

### TECHNICAL FIELD

The present invention relates to a liquid crystal display device. The present invention particularly relates to a liquid crystal display device in which a gap between a pair of substrates is kept constant by spacer particles, the gap being filled with a liquid crystal.

### BACKGROUND ART

A liquid crystal display device includes a liquid crystal panel in which a liquid crystal is held by (i) a glass substrate (hereinafter, referred to as “TFT substrate”) on which TFTs (Thin Film Transistors) are provided and (ii) another glass substrate (hereinafter, referred to as “color filter substrate”) on which RGB pixels are distributed so as to constitute a color filter. The liquid crystal is required to have a uniform thickness (i.e., uniform cell thickness) because a display unevenness of the liquid crystal display device can be also prevented.

Under these circumstances, a conventional liquid crystal device has been produced by use of a method in which (i) spacer particles are randomly and uniformly dispersed all over a substrate on which pixel electrodes are formed and (ii) the thickness of the liquid crystal layer is controlled by the spacer particles thus dispersed.

However, in case of employing such a method by which the spacer particles are randomly dispersed, some of the spacer particles thus dispersed are disposed on the pixel electrodes, i.e., on display sections (pixel regions) of the liquid crystal display device. Generally, each of the spacer particles is made of synthetic resin. Therefore, if the spacer particles are disposed on the pixel electrodes, then the alignment of the liquid crystal is disordered on a surface of each of the spacer particles disposed on the pixel electrodes, thereby causing incident light not to be blocked. This causes a polarization disorder which gives rise to a phenomenon in which a polarization is lost, i.e., a depolarizing phenomenon. The depolarizing phenomenon causes a deterioration in display quality such as contrast and/or color tone. Such a deterioration in display quality leads to a deterioration in display performance and quality.

In order that a problem is prevented that is associated with the method in which the spacer particles are randomly and uniformly dispersed, an alternative method has been under consideration in which the spacer particles are disposed only on a light shielding region (a region separating the pixel regions). Such a method by which the spacer particles are disposed only in a specific section is disclosed in, for example, Patent Literature 1. Patent Literature 1 discloses a method for fixing the spacer particles in a light shielding region of or a region, corresponding to the respective light shielding region, of at least one of two substrates constituting a liquid crystal panel, by (i) causing droplets of a dispersion liquid of the spacer particles to land in a region, having a low-energy surface, of the light shielding region or the region corresponding to the light shielding region, and then (ii) drying the droplets thus landed.

Further, Patent Literature 2 discloses a liquid crystal display panel, in which a pixel and a black matrix are separated by a convex separating wall so as to prevent the spacer particles (bead spacers) disposed in a black matrix region from moving into the pixel. Patent Literature 2 describes that the arrangement makes it possible to prevent an inadequate display caused by the light leakage or alignment disorder due to the movement of the bead spacers.

### CITATION LIST

Patent Literature 1

Japanese Patent Application Publication, Tokukai, No. 2005-10412 A (Publication Date: Jan. 13, 2005)

Patent Literature 2

Japanese Patent Application Publication, Tokukai, No. 2005-258137 A (Publication Date: Sep. 22, 2005)

Patent Literature 3

Japanese Patent Application Publication, Tokukaihei, No. 11-242225 A (Publication Date: Sep. 7, 1999)

Patent Literature 4

Japanese Patent Application Publication, Tokukai, No. 2007-33797 A (Publication Date: Feb. 8, 2007)

### SUMMARY OF INVENTION

Note that a color filter substrate that constitutes a liquid crystal panel includes (i) a colored layer region constituting a pixel region (display region) and (ii) a black matrix region constituting a region excluding the pixel (non-display region).

Here, a size of a spacer particle is determined based on a target cell thickness of the liquid crystal panel. The cell thickness generally indicates a thickness of a liquid crystal layer in the colored layer region serving as the display region (that is, a distance between a surface of a color filter and a surface of a display electrode on a TFT substrate). Therefore, the size of the spacer particle is designed based on the thickness of the liquid crystal layer in the colored layer region.

Note however that the black matrix region has generally been made of resin, recently. The black matrix region has a layer thickness of 2.0 μm to 3.0 μm. In contrast, the colored layer region has a layer thickness of 1.7 μm to 2.0 μm. That is, the black matrix region and the colored layer region are different from each other in terms of thickness, as well as in terms of manufacturing process (see FIG. 11). Therefore, if the spacer particles are disposed only in a region in which the black matrix is provided, then a thickness of the black matrix and a thickness of a bus line electrode facing the black matrix are added to the cell thickness which is defined by the distance between the colored layer and the display electrode facing the colored layer. This causes a problem that the cell thickness becomes no longer a target thickness. Further, a fluctuation in film thickness during the manufacturing process also causes the cell thickness to become no longer a target thickness. If the cell thickness becomes thus no longer the target thickness, then the cell thickness largely varies when the liquid crystal is injected. This affects an optical performance, and also causes an air bubble or irregularity of the cell thickness due to variation in liquid crystal injection period. As a result, defects such as flicker of display due to vibration may occur.

Meanwhile, in a case where the cell thickness (a distance between the colored layer of the color filter substrate and the display electrode layer of the TFT substrate) is controlled by the spacer particles disposed in the black matrix region, the size of each of the spacer particles must generally be small (for example, approximately 2.8 μm). However, a diameter of a general-purpose spacer particle falls within a range of 3.5 μm to 5.0 μm. A spacer particle having a diameter outside the range is hard to find and expensive.

Further, elastic deformation amount of spacer particles decreases as the spacer particles become smaller in diameter. It follows that the defects in quality is easy to occur.

The present invention has been made in view of the problems, and its object is to achieve an arrangement of a liquid crystal display device in which a cell thickness is accurately set and inexpensive spacer particles having a relatively large diameter can be used.

In order to attain the above object, the liquid crystal display device according to the present invention is a liquid crystal display device including a liquid crystal panel which includes: a color filter substrate; an element substrate; and a liquid crystal layer provided between the color filter substrate and the element substrate, spacer particles for keeping the gap between the color filter substrate and the element substrate being disposed in regions of the liquid crystal layer which correspond to respective non-display regions of the liquid crystal panel, and layers being provided in regions of the color filter, the regions corresponding to the respective non-display regions in which the spacer particles are disposed, the layers having a thickness equal to that of colored layers provided in regions corresponding to respective display regions.

This arrangement makes it possible to cause (i) the height of the color filter substrate in the non-display region where the spacer particles are disposed and (ii) the height of the color filter substrate in the display region where the colored layer is provided to be equal to each other. This makes it possible to cause (a) the cell thickness of the display region and (b) the cell thickness of the non-display region where the spacer particles are disposed to be substantially equal to each other, in contrast to the conventional arrangement in which the cell thickness (distance between the two substrates facing each other, that is, a thickness of the liquid crystal layer) was different between the display region and the non-display region due to black matrix resin provided in the non-display region, the black matrix resin having a thickness approximately 0.3 to 1.0 μm larger than that of the colored layer. The two substrates further include therebetween alignment films on both sides of the liquid crystal layer; however, there is no need to take into account thickness of these alignment films since the thickness is small.

As a result, even in a case where the spacer particles having a size determined based on the cell thickness of the display regions are disposed in the non-display regions, it is possible that the display regions have a target cell thickness.

With the arrangement, it is possible to provide a liquid crystal display device that is capable of accurately controlling the cell thickness, by preventing a deviation of the cell thickness from the target thickness, which deviation is caused by a difference between the cell thickness of the display region and the cell thickness of the non-display region in which the spacer particles are disposed.

Further, with the arrangement, it is possible to set the cell thickness to become a target one with use of a general-purpose spacer particle having a relatively large diameter. That is, it is possible to achieve a liquid crystal display device having the target cell thickness with use of a general-purpose, inexpensive spacer particle.

Furthermore, with the arrangement, it is possible to employ a spacer particle having a large diameter and a large elastic deformation. As such, an amount of the liquid crystal to be injected can be substantially fixed, thereby achieving an easy control of the cell thickness.

The liquid crystal display device of the present invention is preferably arranged such that the layers having the thickness equal to that of the colored layers are respective colored layers.

With this arrangement, it is possible to form, in the manufacturing process of the color filter substrate, the colored layer in the non-display region through a same process as that of the colored layer in the display region. This makes it possible to easily manufacture the color filter substrate. In addition, it is possible to minimize a difference between the thickness of the liquid crystal layer in the non-display region in which the spacer particle is disposed and the thickness of the liquid crystal layer in the display region.

The liquid crystal display device of the present invention is preferably arranged such that light shielding layers provided on the element substrate so that the light shielding layers and the colored layers provided in the respective non-display regions of the color filter substrate overlap each other.

With this arrangement, even in a case where the colored layer having an optical transparency is provided in the non-display region, it is possible to surely prevent light leakage because the light shielding layer is provided so that the light shielding layer and the colored layer overlap each other, when viewed from an observer of the liquid crystal panel. The light shielding layer can be made, for example, of source metal.

The liquid crystal display device of the present invention is preferably arranged such that data wires, scanning wires, auxiliary capacitor wires, and switching elements are patterned on the element substrate, and the spacer particles are disposed on the auxiliary capacitor wires.

With this arrangement, it is possible to surely prevent the light leakage. This is because the auxiliary capacitor wire has a potential as low as that of a counter electrode (a transparent electrode in the non-display region), and therefore, even if the potentially floating light shielding layer is provided so that the light shielding layer and the colored layer overlap each other, electrical field therearound is not so much affected. As such, malfunction of the liquid crystal can be prevented.

In the present invention, it is also possible to bifurcate each of the auxiliary capacitor wires into two auxiliary capacitor wires and then dispose the spacer particles between the two auxiliary capacitor wires thus bifurcated. In the present Description, such an arrangement is also regarded as the arrangement in which the spacer particles are disposed on the auxiliary capacitor wires.

The liquid crystal display device of the present invention is preferably configured such that data wires, scanning wires, and switching elements are patterned on the element substrate, and the spacer particles are disposed on the scanning wires.

The scanning wires have a relatively large line width so as to transmit electricity for electrically switching the switching elements. Therefore, the arrangement has such an advantage that it is possible to provide the light shielding layer having a large line width (including a region from which light leaks due to malfunction of the liquid crystal) without affecting an aperture ratio, thereby surely preventing the light leakage.

In the present invention, it is also possible to bifurcate each of the scanning wires into two scanning wires and then dispose the spacer particles between the two scanning wires thus bifurcated. In the present Description, such an arrangement is also regarded as the arrangement in which the spacer particles are disposed on the scanning wires.

The liquid crystal display device of the present invention is preferably arranged such that the element substrate has projecting walls, by which the spacer particles are surrounded, provided in the regions of the element substrate which correspond to the respective non-display regions of the liquid crystal panel.

According to the arrangement, spherical spacer particles provided between the element substrate and the color filter substrate are to be surrounded by the projecting walls. As such, it is possible to prevent the spacer particles disposed in the non-display region from moving into the display region, even if vibration is applied to the liquid crystal display device. As a result, it is possible to prevent deterioration in display quality due to movement of the spacer particles into the display region.

Further, with the arrangement, it is possible to keep the thickness of the liquid crystal layer constant, since the spacer particles are surely disposed in a predetermined region of the liquid crystal layer. This makes it possible to prevent irregularity of the cell thickness.

The liquid crystal display device of the present invention is preferably arranged such that the color filter substrate has projecting walls, by which the spacer particles are surrounded, provided in the regions of the color filter substrate which correspond to the respective non-display regions of the liquid crystal panel.

According to the arrangement, spherical spacer particles provided between the element substrate and the color filter substrate are to be surrounded by the projecting walls. As such, it is possible to prevent the spacer particles disposed in the non-display region from moving into the display region, even if vibration is applied to the liquid crystal display device. As a result, it is possible to prevent deterioration in display quality due to movement of the spacer particles into the display region.

The projecting walls formed on the color filter may be formed by, for example, stacking the black matrix and the colored layer. Alternatively, it is possible to utilize ribs, which are provided on the color filter substrate for controlling alignment of the liquid crystal molecules, as the projecting walls.

The liquid crystal display of the present invention is preferably arranged such that the color filter substrate has black matrices provided in regions corresponding to non-display regions in which no spacer particle is disposed, and the black matrices are larger in thickness than the colored layers.

With the arrangement, it is possible to prevent the spacer particles from moving into the display region, since the black matrices serve as the projecting walls.

The method according to the present invention for manufacturing a liquid crystal display device is a method including the step of: concurrently forming the colored layers of the display regions and the colored layers of the non-display regions in a single manufacturing step.

According to the method of the present invention, it is possible to manufacture a liquid crystal display device in which: a difference between the thickness of the display region and the thickness of the non-display region is minimized; a deviation of the cell thickness from the target thickness is prevented; and the cell thickness can be accurately set. This is because, according to the method of the present invention, the colored layer in the display region of the colored filter and the colored layer in the non-display region of the colored filter are manufactured in a single process.

Further, according to the method of the present invention, it is possible to control the cell thickness to become a target one by controlling only the thickness of the colored layer, without measuring the thickness of the black matrix, an interlayer insulating film, or the like. It is also possible to unambiguously determine a required amount of the liquid crystal based on a diameter of the spacer particles.

For a fuller understanding of the nature and advantages of the invention, reference should be made to the ensuing detailed description taken in conjunction with the accompanying drawings.

### BRIEF DESCRIPTION OF DRAWINGS

FIG. 1

FIG. 1, showing an arrangement of a liquid crystal display device according to an embodiment of the present invention, is a cross-sectional view taken along the line X-X′ of FIG. 2.

FIG. 2

FIG. 2 is a plan view illustrating an arrangement of a TFT substrate provided in the liquid crystal display device according to an embodiment of the present invention.

FIG. 3

FIG. 3, showing an arrangement of the liquid crystal display device according to a second embodiment of the present invention, is a cross-sectional view taken along the line Y-Y′ of FIG. 4.

FIG. 4

FIG. 4 is a plan view illustrating an arrangement of a TFT substrate provided in the liquid crystal display device according to the second embodiment of the present invention.

FIG. 5

(a) of FIG. 5 is a schematic view illustrating how liquid crystal molecules are aligned in the liquid crystal display device of FIG. 3, while no voltage is applied. (b) of FIG. 5 is a schematic view illustrating how liquid crystal molecules are aligned in the liquid crystal display device of FIG. 3, while a voltage is applied.

FIG. 6

FIG. 6 is a cross-sectional view illustrating another arrangement of the liquid crystal display device according to the second embodiment of the present invention.

FIG. 7

FIG. 7 is a cross-sectional view illustrating still another arrangement of the liquid crystal display device according to the second embodiment of the present invention.

FIG. 8

FIG. 8 is a plan view illustrating another arrangement of the liquid crystal display device according to the second embodiment of the present invention.

FIG. 9

FIG. 9 is a plan view illustrating still another arrangement of the liquid crystal display device according to the second embodiment of the present invention.

FIG. 10

FIG. 10 is a plan view illustrating yet another arrangement of the liquid crystal display device according to the second embodiment of the present invention.

FIG. 11

FIG. 11 is a cross-sectional view illustrating a arrangement of a conventional liquid crystal display device.

### EXPLANATION OF REFERENTIAL NUMERALS

10 Liquid Crystal Panel
11 Gate Wire
12 Source Wire
12c Source Metal Layer (Light Shielding Layer)
13 TFT Element (Thin Film Transistor)
14 Auxiliary Capacitor Wire
15 Pixel Electrode
20 TFT Substrate (Element Substrate)
22 Projecting Wall
30 Color Filter Substrate
32 Color Filter Layer
32a Colored Part (Colored Layer)
32b Black Matrix
40 Liquid Crystal Layer
50 Spacer Particle
100 Liquid Crystal Panel
100a Liquid Crystal Panel
100b Liquid Crystal Panel

### DESCRIPTION OF EMBODIMENTS

### Embodiment 1

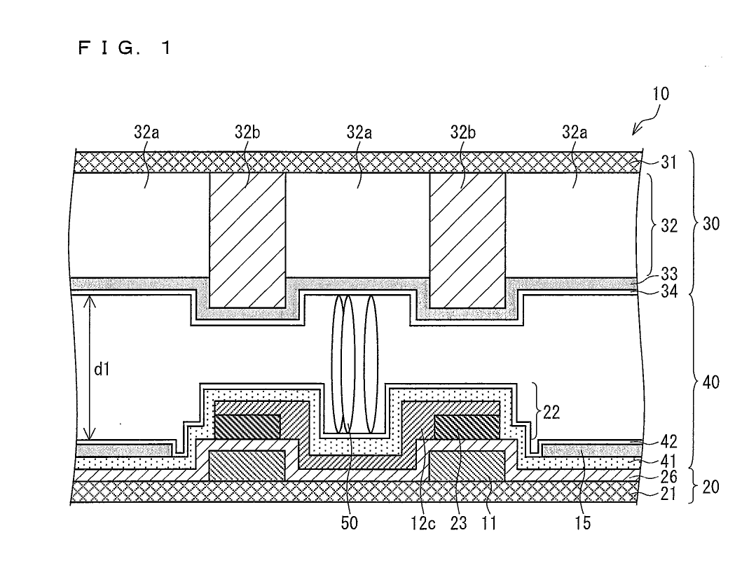

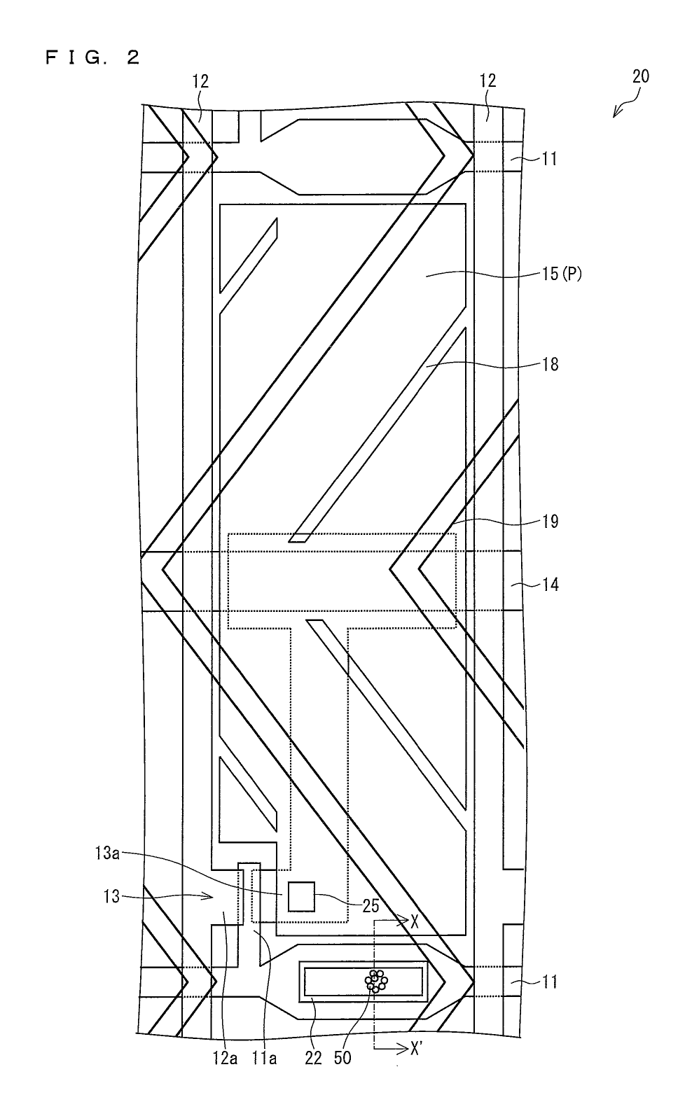

An embodiment of the present invention is described below with reference to FIGS. 1 and 2. Note however that the present invention is not limited to Embodiment 1.

The present embodiment exemplifies a liquid crystal display device which includes a liquid crystal panel including: a color filter substrate, a TFT substrate (element substrate), and a liquid crystal layer provided between the color filter substrate and the TFT substrate. FIG. 1 is a cross-sectional view showing an arrangement of a liquid crystal panel 10, which is provided in the liquid crystal display device according to the present embodiment. FIG. 2 shows a partial arrangement of a TFT substrate (element substrate) 20 that constitutes the liquid crystal panel 10. The cross-sectional view shown in FIG. 1 is taken along the line X-X' of FIG. 2.

As shown in FIG. 1, the liquid crystal panel 10 includes: the TFT substrate 20 and a color filter substrate 30 which are provided so as to face each other; and a liquid crystal layer of a vertical alignment (VA) type, which is provided between the TFT substrate 20 and the color filter substrate 30. In the liquid crystal layer 40 (that is, in a gap between the TFT substrate 20 and the color filter substrate 30), spherical spacer particles 50 are disposed for controlling a thickness (also referred to as “a distance between the TFT substrate 20 and the color filter substrate 30″ or “cell thickness”) of the liquid crystal layer 40. It should be noted in FIG. 1 that the spacer particles 50 are scaled down in the X-X′ line direction, for convenience. Each of the spacer particles 50 is made of plastic bead. Further, vertical alignment films 42 and 34 are provided on uppermost surfaces, on a liquid crystal layer 40 side, of the TFT substrate 20 and the color filter substrate 30, respectively.

As shown in FIG. 2, the TFT substrate 20 includes: a plurality of gate wires 11 that are provided in parallel with one another so as to extend in a lateral direction of FIG. 2; a plurality of source wires (data wires) 12 that are provided in parallel with one another so as to extend in a longitudinal direction (a direction orthogonal to each of the gate wires 11) of FIG. 2; thin film transistors (TFT element (switching element)) 13 that are provided at respective intersections of the gate wires (scanning wires) 11 and the source wires 12; auxiliary capacitor wires (CS wires) 14 each provided so as to extend between corresponding adjacent gate wires 11; pixel electrodes (ITO) 15, provided for the respective thin film transistors, each of which is provided in a region surrounded by corresponding adjacent two gate wires 11 and corresponding adjacent two source wires 12; and projecting walls 22 provided on the respective plurality of gate wires 11 so as to surround the spacer particles 50 in a rectangular frame manner.

Further, as shown in FIG. 2, each of the pixel electrodes 15 has a slit pattern 18 for controlling an alignment direction of the liquid crystal molecules. A rib pattern 19 for controlling the alignment direction of the liquid crystal molecules is provided on the color filter substrate 30 so as to match the slit pattern 18. FIG. 2 illustrates a state in which the rib pattern 19 that is provided on the color filter substrate 30 is projected onto the TFT substrate 20. While a voltage exceeding a threshold voltage is applied to each of the pixel electrodes 15, liquid crystal molecules are aligned in a direction perpendicular to the rib pattern 19 and to the slit pattern 18. The rib pattern and the slit pattern are disclosed by, for example, Patent Literature 3.

Furthermore, in the TFT substrate 20, each of the pixel electrodes 15 constitutes a pixel P that is a minimum unit of an image. The pixels P are arranged in a matrix manner so as to constitute the display region. A region other than the region in which the pixels P are arranged is the non-display region. According to the liquid crystal display device of the present invention, the spacer particles 50 are disposed in a region corresponding to the non-display region, in the liquid crystal layer 40. A well-known method such as an ink-jet method can be used as the method by which the spacer particles are thus dispersed in a fixed region. Alternatively, it is possible to utilize a method described in the Patent Literature 1.

As shown in FIGS. 1 and 2, each TFT element 13 includes: a gate electrode 11a which is a part projecting sideward from a corresponding gate wire 11 that is provided on the glass substrate 21; a gate insulating film (GI; that is, a gate insulator made of SiOx, SiNx, or the like) 26 provided so as to cover the gate electrode 11a; a semiconductor layer 23 stacked on the gate insulating film 26; a source electrode 12a and a drain electrode 13a which are provided on the semiconductor layer 23 so as to face each other; and a passivation film 41 (PAS; that is, a passivation member made of SiNx).

The source electrode 12a is a part projecting sideward from the source wire 12. The drain electrode 13a is connected to a pixel electrode 15 through a contact hole 25 of the protective film 41 provided on a source metal layer. The drain electrode 13a extends up to a central region of the pixel P where the auxiliary capacitor wire 14 is provided so as to form an auxiliary capacitor electrode. The auxiliary capacitor electrode, the auxiliary capacitor wire 14, and the gate insulating film 26 constitutes an auxiliary capacitance.

In the TFT substrate 20 having the arrangement, the projecting wall 22 serves as means for preventing the movement of the spacer particles 50 inside the projecting wall 22. As shown in FIG. 1, the projecting wall 22 is formed by stacking a source metal layer (light shielding layer) 12c on the semiconductor layer 23.

As shown in FIG. 1, the source metal layer 12c is provided not only in a region of the projecting wall 22, but also in a region in which the spacer particles 50 are disposed. The source metal layer having a light blocking characteristic is provided so that (i) the source metal layer and (ii) a colored part 32a in the non-display region of the color filter substrate overlap each other. This makes it possible to surely prevent light from being leaked from the colored layer 32a of the non-display region.

In the present embodiment, the gate wire 11 is bifurcated in the region in which the spacer particles 50 are disposed (see FIGS. 1 and 2). This causes the gate wire to be also a constituent element of the projecting wall 22. As such, it is possible to increase a height difference between the projecting wall 22 and a recessed part surrounded by the projecting wall 22, thereby further preventing the movement of the spacer particles. Generally, the transparent electrode, via which a voltage is applied to the liquid crystal, is a thin film, and therefore has a small fluctuation in film thickness. It is preferable that the spacer particles not be disposed on the gate wire having an especially large film thickness.

As shown in FIG. 1, the color filter substrate 30 is arranged so that a color filter layer 32, an ITO film 33, and the alignment film 34 are stacked in this order on the glass substrate 31. The ITO film 33 serves as a counter electrode.

The color filter layer 32 includes colored parts (colored layers) 32a, provided so as to correspond to the respective pixels P, which is colored red (R), green (G), or blue (B); and black matrices 32b, serving as a light shielding film, provided between the colored parts 32a.

More specifically, the colored parts 32a are provided so as to correspond to regions where the respective pixel electrodes (ITO) 15, corresponding to respective display regions of the liquid crystal panel, are provided. Whereas, the black matrices 32b are provided so as to correspond to regions corresponding to the respective non-display regions of the liquid crystal panel.

Note in the color filter substrate 30 of the present embodiment that a colored part 32a, which is identical to a colored part 32a provided in a display region, is also provided in a region where the spacer particles 50 are disposed.

This makes it possible to cause (i) the thickness of the color filter layer 32 in the non-display region where the spacer particles 50 are disposed and (ii) the thickness of the color filter layer 32 in the display region to be equal to each other. As a result, as shown in FIG. 1, it is possible to cause (a) the height of the color filter substrate 30 in the non-display region where the spacer particles 50 are disposed and (b) the height of the color filter substrate 30 in the display region where the colored part 32a is provided to be equal to each other.

In contrast, FIG. 11 shows, for comparison, a cross-sectional view of a conventional liquid crystal display device. FIG. 11 is a cross-sectional structure of the liquid crystal display device which is disclosed in Patent Literature 4. A liquid crystal panel 10′ of the liquid crystal display device (see FIG. 11) includes a color filter substrate 30′ instead of the color filter substrate 30. A TFT substrate 20 and a liquid crystal layer 40 have the same arrangements as those described in the liquid crystal panel 10 of FIG. 1. Therefore, The TFT substrate 20 and the liquid crystal layer are assigned the same referential numerals as those described in FIG. 1, and explanations thereof are omitted here. Note that the liquid crystal display device 10′ of FIG. 11 includes no projecting wall 22 for preventing the movement of the spacer particles 50.

The color filter substrate 30′ provided in the liquid crystal panel 10′ is arranged such that a color filter layer 32′, an ITO film 33, and an alignment film 34 are stacked in this order on a glass substrate 31.

The color filter layer 32′ includes colored parts (colored layers) 32a′, provided so as to correspond to the respective pixels P, which is colored red (R), green (G), or blue (B); and black matrices 32b′, serving as a light shielding film, provided between the colored parts 32a′.

Unlike the color filter layer 32 of FIG. 1, the color filter layer 32′ is arranged such that the colored parts 32a′ are provided only in respective regions corresponding to regions (i) which correspond to respective display regions of the liquid crystal panel and (ii) in which respective pixel electrodes (ITO) 15 are provided. In regions that correspond to respective non-display regions (regions other than the display regions), the black matrices 32b′ are uniformly provided.

The liquid crystal panel 10′ of FIG. 11 was thus arranged such that a cell thickness d2 in each of the display regions and a cell thickness d3 in each of the non-display regions are different from each other (i.e., a distance (a thickness of the liquid crystal layer) in each of the display regions between the two substrates facing each other was different from that in each of the non-display regions). This is because the black matrices 32b′, having approximately 0.3 to 1.0 μm larger layer thickness than the colored part 32a′, were provided in the respective non-display regions. Further, according to the liquid crystal panel 10′, the black matrices and the colored parts were manufactured through respective different manufacturing processes. This caused a larger fluctuation in thickness.

This caused the following problem. Specifically, in a case where spacer particles 50, designed for controlling a cell thickness d2 in a display region in which a colored part 32a′ is provided, are dispersed in a non-display region in which a black matrix 32b′ is provided, then the cell thickness largely varies due to a film thickness of the black matrix 32b′. In order to address the problem, it is necessary that expensive spacer particles having a smaller diameter be used. The liquid crystal panel 10′ had another problem that the cell thickness largely varies also due to a film thickness of gate wires.

In contrast, according to the liquid crystal panel 10 provided in the liquid crystal display device of the present embodiment (see FIG. 1), the colored parts 32a are provided in the respective regions where the spacer particles 50 are disposed. As such, it is possible to cause (i) the cell thickness in each of the display regions and (ii) the cell thickness in each of the non-display regions where the spacer particles 50 are disposed to be substantially equal to each other.

As a result, even in a case where the spacer particles having a size determined based on the cell thickness of the display regions are disposed in the non-display regions, it is possible that the display regions have a target cell thickness.

With the arrangement, it is possible to provide a liquid crystal display device that is capable of accurately controlling the cell thickness, by preventing a deviation of the cell thickness from the target thickness, which deviation is caused by (i) a difference between the film thickness of the color filter substrate in each of the display regions and the film thickness of the color filter substrate in each of the non-display regions and (ii) a variation in the film thickness that occurs during the manufacturing process.

Conventionally, in order to accurately control the cell thickness d, it is necessary to control the following three parameters: a thickness of the black matrices; a thickness of the colored parts; and a diameter of the spacer particles. In contrast, according to the present invention, it is possible to obtain a target cell thickness d1 only by accurately controlling the thickness of the colored parts.

Since the target cell thickness can be thus obtained, it is possible to obtain the target cell thickness, by injecting a fixed amount of liquid crystal for a fixed diameter of the spacer particles in a liquid crystal injecting process during manufacturing of the liquid crystal display device. In this regard, see the following description.

Spacer particles whose diameter is chosen so as to be equal to a determined cell thickness d are disposed in the non-display regions of the liquid crystal display device. Here, in order for the spacer particles to have an elastic deformation of approximately 95%, it is preferable that a spacer diameter D satisfy, for example, D=d/0.95 wherein d is the cell thickness.

On the other hand, there are two following factors that should be taken into account when the liquid crystal is drop-injected; one is a volume occupancy ratio p of a rib and the other is a volume occupancy ratio q of a portion projecting from a surface of an ITO constituting a pixel. These factors should be taken into account because they have a large volume with respect to a display area S and therefore cause a decrease in volume (of the liquid crystal layer). Accordingly, a mass of liquid crystal to be injected is represented by a formula ρ·S·(d−p−q), where ρ is specific gravity.

Conventionally, the cell thickness d in the formula has been a large variable factor. However, the liquid crystal display device having the arrangement makes it possible to obtain the target cell thickness, thereby minimizing the fluctuation of the cell thickness d.

In other words, there is no need to adjust the mass of the liquid crystal to be injected every time the liquid crystal is injected, once the amount of the liquid crystal to be injected is found based on a predetermined cell thickness. This is because the variation of the cell thickness d is a minimum value. As a result, it becomes possible to find the amount of required liquid crystal based on the target cell thickness and based on the diameter of the spacer particles, without measuring a thickness of the projecting portion of the black matrix or the like.

According to the present embodiment, the liquid crystal layer 40 is a vertical alignment type liquid crystal layer in which liquid crystal molecules of a nematic liquid crystal material are aligned perpendicular to a surface of a substrate while no voltage is applied. Also, the liquid crystal layer 40 is used in a liquid crystal display device operating in a normally black mode in which the liquid crystal panel is in a black display state while no voltage is applied. As such, it is possible to more efficiently prevent the light from being leaked from the colored parts 32a provided in the respective non-display regions.

Further, according to the present embodiment, the black matrices 32b are larger in thickness than the colored parts 32a. As such, the black matrix serves as the projecting wall, thereby preventing the spacer particles from moving into the respective display regions.

Next, the following describes a method for manufacturing the liquid crystal panel 10 provided in the liquid crystal display device of the present embodiment. The method for manufacturing the liquid crystal panel 10 is roughly categorized into the following three steps: a step of manufacturing a TFT substrate; a step of manufacturing a color filter substrate; and a step of manufacturing a liquid crystal panel (a step in which two substrates are combined with each other and liquid crystal is filled in between the substrates thus combined). The following describes each of the three steps.

### <Step of Manufacturing TFT Substrate>

First, a metal film made of titanium, aluminum, or the like is formed on a glass substrate 21 by a sputtering method so that the metal film has a film thickness of approximately 3000 Å. Next, gate wires 11, gate electrodes 11a, and auxiliary capacitor wires 14 are patterned by a photolithographic technique.

Then, a film of silicon nitride, silicon oxide, or the like is formed, by a CVD (Chemical Vapor Deposition) method, all over a substrate on which the gate wire 11, the gate electrode 11a, and the auxiliary capacitor wire 14 are formed, so that the film has a thickness of approximately 4600 Å. A gate insulating film 26 is thus formed.

Further, an n+ amorphous silicon film (film thickness of approximately 500 Å) to which phosphoros is added and intrinsic amorphous silicon films (film thickness of approximately 1500 Å) are sequentially formed, by the CVD method, all over the substrate on which the gate insulating film 26 is formed. A semiconductor layer is thus formed. After that, the semiconductor layers are patterned by the photolithographic technique. The semiconductor layers thus patterned will constitute TFT elements 13 and projecting walls 22.

Then, a metal film made of titanium, aluminum, or the like is formed, by the sputtering method, all over the substrate on which the semiconductor layer is formed so that the metal film has a thickness of approximately 3600 Å. Thereafter, the metal film is patterned by the photolithographic technique so as to form source wires 12, source electrodes 12a, drain electrodes 13a, and source metal layers 12c.

This causes formation of the projecting walls 22 constituted by the semiconductor layers 23 and the source metal layers 12c.

Next, with use of the source electrodes 12a and the drain electrodes 13a as masks, the n+ amorphous silicon film of the semiconductor layers is etched and removed so as to form a channel section. The TFT elements 13 are thus formed.

Furthermore, a silicon nitride film or the like is formed, by the CVD method, all over the substrate on which the TFT elements 13 are formed so as to have a film thickness of approximately 3000 Å. After that, contact holes 25 are patterned on the respective drain electrodes 13a by the photolithographic technique. A protective insulating film (a passivation film) is thus formed.

Then, an ITO (Indium Tin Oxide) film, which is a compound of indium oxide and tin oxide, is formed by the sputtering method all over the substrate on which the protective insulating film is formed so as to have a film thickness of approximately 700 Å. After that, the ITO film is patterned by the photolithographic technique so that pixel electrodes 15 are formed.

Lastly, polyimide resin which causes the liquid crystal molecules to be vertically aligned is applied by an ink-jet method or a flexographic printing method all over the substrate on which the pixel electrodes 15 are formed. Thereafter, the substrate is subjected to pre-bake and post-bake. An alignment film 42 is thus formed.

The TFT substrate 20 can be manufactured through the above-described steps.

### <Step of Manufacturing Color Filter Substrate>

First, a photoresist colored black by carbon or the like is formed on a glass substrate 31 so that the photoresist has a film thickness of approximately 2.0 μm to 3.0 μm. Next, the photoresist is patterned by the photolithographic technique so as to form black matrices 32b. Here, the black matrices 32b formed on non-display regions where spacer particles 50 are to be disposed should be removed, and instead colored parts 32a are disposed there.

Next, a photoresist that is dispersed and colored by pigments for red, green, and blue is formed in each region between adjacent black matrices 32b (a region in which no black matrix 32b is formed) so that the photoresist has a film thickness of approximately 1.7 μm to 2.0 μm. After that, the colored parts 32a are formed by patterning the photoresist with the use of the photolithographic technique. This causes a color filter layer 32 including the colored parts 32a and the black matrices 32b to be formed. In this step of forming the colored parts 32a, colored parts 32a in the non-display regions and colored parts 32a in the display regions are concurrently formed.

Then, a rib and an auxiliary rib (see Patent Literature 3), which are generally used in an MVA mode, are patterned by the photolithographic technique so that an ITO film 33 having a thickness of approximately 1400 Å is formed all over the substrate.

Lastly, polyimide resin which causes the liquid crystal molecules to be vertically aligned is applied by an ink-jet method or a flexographic printing method all over the substrate on which the ITO film 33 are formed. Thereafter, the substrate is subjected to pre-bake and post-bake. An alignment film 34 is thus formed.

The color filter substrate 30 can be manufactured through the above-described steps.

### <Step of Manufacturing Liquid Crystal Panel>

First, onto one of the TFT substrate 20 and the color filter substrate 30 manufactured through the above-mentioned steps, a sealing agent such as that causes ultraviolet curing and heat-curing is applied in a rectangular manner in a picture-frame region or outside the picture-frame region, by use of dispenser drawing application or the like.

Next, the spacer particles 50 are caused, by an ink-jet method, to (i) land inside the projecting walls 22 formed on a surface of the TFT substrate 20 on which the sealing agent is applied and drawn or (ii) land in the color filter parts 32a in the non-display regions. After that, spacer particles 50 are dried and baked so that adhesive layers around the respective spacer particles 50 are lysed and fixed.

The spacer particles 50 are selected so as to have a diameter causing the spacer particles 50 to have a compression ratio of 95% to 100% with respect to the cell thickness. Further, each of the spacer particles has, on its surface, a fixing layer whose thickness is approximately 0.05 μm to 0.10 μm. Note that a composition of materials of which the spacer particles are made is described in, for example, Patent Literature 4.

Then, a liquid crystal material is dropped on the TFT substrate 20 on which the spacer particles 50 are disposed. Thereafter, inside a vacuum chamber, (i) the TFT substrate 20 on which the liquid crystal material was dropped and (ii) the color filter substrate 30 manufactured through the above-described steps are positioned, and are then combined with each other.

Lastly, the sealing agent provided between the TFT substrate 20 and the color filter substrate 30 which are combined with each other is exposed to UV light so as to be preliminarily-cured. Thereafter, the sealing agent thus preliminarily-cured is subjected to fully cured by heat. The liquid crystal layer 40 is thus formed.

The liquid crystal panel 10 of the present embodiment can be manufactured through the above-described steps.

According to the arrangement of the present embodiment, the only variable factor of the cell thickness is related to the spacer particles. Therefore, it is possible to determine an amount of the liquid crystal to be injected in accordance with the cell thickness, without measuring, in advance, the thickness of the black matrices 32b and the thickness of the colored parts 32a. As such, it is possible to control the cell thickness to become a target one, thereby simplifying the manufacturing process. This allows a reduction in production cost since there is no need for investing in facilities such as a film thickness measuring system.

### Embodiment 2

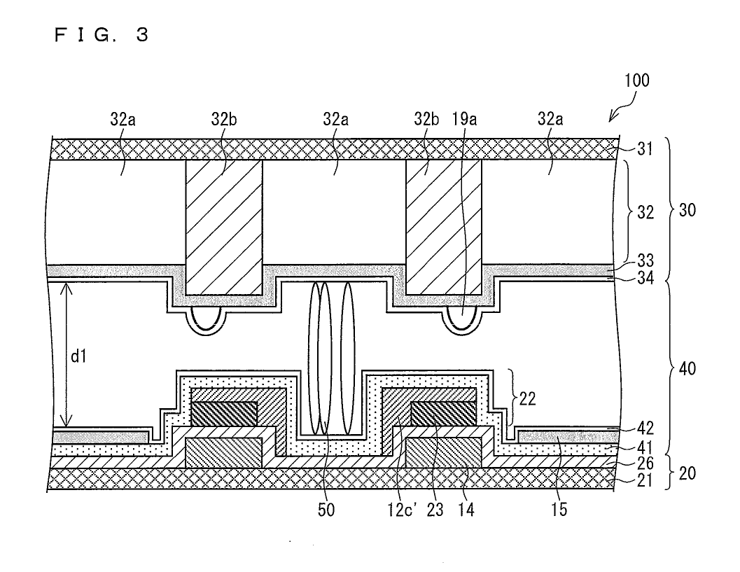

The second embodiment of the present invention is described below with reference to FIGS. 3 to 10. Note however that the present invention is not limited to Embodiment 2.

Embodiment 1 dealt with an example in which the spacer particles are disposed on the gate wires. In contrast, Embodiment 2 will deal with an example in which spacer particles are disposed on auxiliary capacitor wires (CS wires).

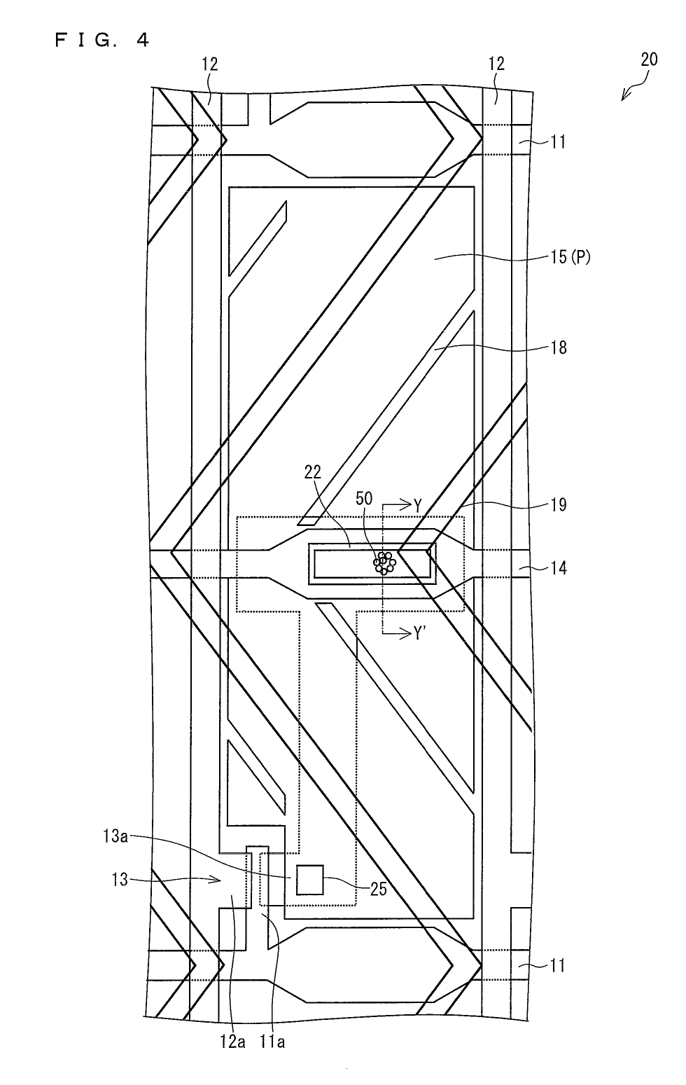

FIG. 3 is a cross-sectional view illustrating an arrangement of a liquid crystal panel 100 provided in a liquid crystal display device according to the present embodiment. FIG. 4 is a partial arrangement of a TFT substrate (element substrate) 20 constituting the liquid crystal panel 100. FIG. 3 is a cross-sectional view taken along the line Y-Y′ of FIG. 4.

The present Embodiment 2 merely describes differences between the liquid crystal panel 100 of Embodiment 2 and the liquid crystal panel 10 of Embodiment 1. Descriptions of other parts of the liquid crystal panel 100 are omitted here. Further, in the liquid crystal panel 100, the same members as those assigned to in the liquid crystal panel 10 are provided with the respective same referential numerals.

As shown in FIGS. 3 and 4, a TFT substrate 20 includes: a plurality of gate wires 11 that are provided so as to extend in a lateral direction of FIG. 4, and so as to be in parallel with one another; a plurality of source wires 12 that are provided so as to extend in a longitudinal direction (a direction orthogonal to the gate wires 11) of FIG. 4, and so as to be in parallel with one another; thin film transistors (TFT elements) that are provided at respective intersections of the plurality of gate wires 11 and the plurality of source wires 12; auxiliary capacitor wires (CS wires) 14 each of which is provided so as to extend between adjacent ones of the plurality of gate wires 11; pixel electrodes (ITO) 15 provided so as to correspond to the respective TFT elements 13, in respective regions surrounded by adjacent ones of the plurality of gate wires 11 and adjacent ones of the plurality of source wires 12; and projecting walls 22 in a rectangular frame manner, on the respective CS wires 14, so as to surround spacer particles 50.

In the present embodiment, the auxiliary capacitor wire 14 is bifurcated in the region in which the spacer particles 50 are disposed (see FIGS. 3 and 4). In other words, a recessed part is provided also on each of the auxiliary capacitor wires so as to match a recessed part surrounded by a corresponding one of the projecting walls 22. This causes each of the plurality of gate wires to constitute a corresponding one of the projecting walls 22. As such, it is possible to increase a height difference between each of the projecting walls 22 and a corresponding recessed part surrounded by the each of the projecting walls 22, thereby preventing the movement of the spacer particles.

Further, as shown in FIG. 4, each of the pixel electrodes 15 has a slit pattern 18 for controlling an alignment direction of the liquid crystal molecules. In addition, a rib pattern 19 for controlling the alignment direction of the liquid crystal molecules is provided on the color filter substrate 30 so as to match the slit pattern 18. FIG. 4 illustrates a state in which the rib pattern 19 that is provided on the color filter substrate 30 is projected onto the TFT substrate 20.

According to the liquid crystal panel 100 of the present embodiment, auxiliary ribs 19a (projecting walls) are provided on an alignment film 34 in a region where the black matrices 32b are provided (see FIG. 3). The auxiliary ribs 19a are provided for aligning the liquid crystal molecules around the respective pixels so as to improve a contrast. Note that such auxiliary ribs 19a can be also preferably utilized for fixing the spacer particles 50.

As described above, in the TFT substrate 20 having the above-described arrangement, the projecting walls 22 and the auxiliary ribs 19a serve as respective projecting walls that are for preventing the movement of the spacer particles 50 inside the projecting walls. The projecting walls 22 are formed by stacking source metal layers (light shielding layers) 12c′ on respective semiconductor layers 23, in the same manner as described in Embodiment 1 (see FIG. 3).

Note in the liquid crystal panel 100 that the source metal layers 12c′ are formed only in the regions where the projecting walls 22 are provided (i.e., the regions where the CS wires 14 are provided), and not in the regions where no projecting wall 22 is provided (i.e., the recessed parts surrounded by the respective projecting walls 22).

This is because a black display is always carried out with respect to each of the CS wires in a liquid crystal panel of a VA type (i.e., a normally black mode), and therefore the necessity for providing the light shielding layer on the CS wires is not great.

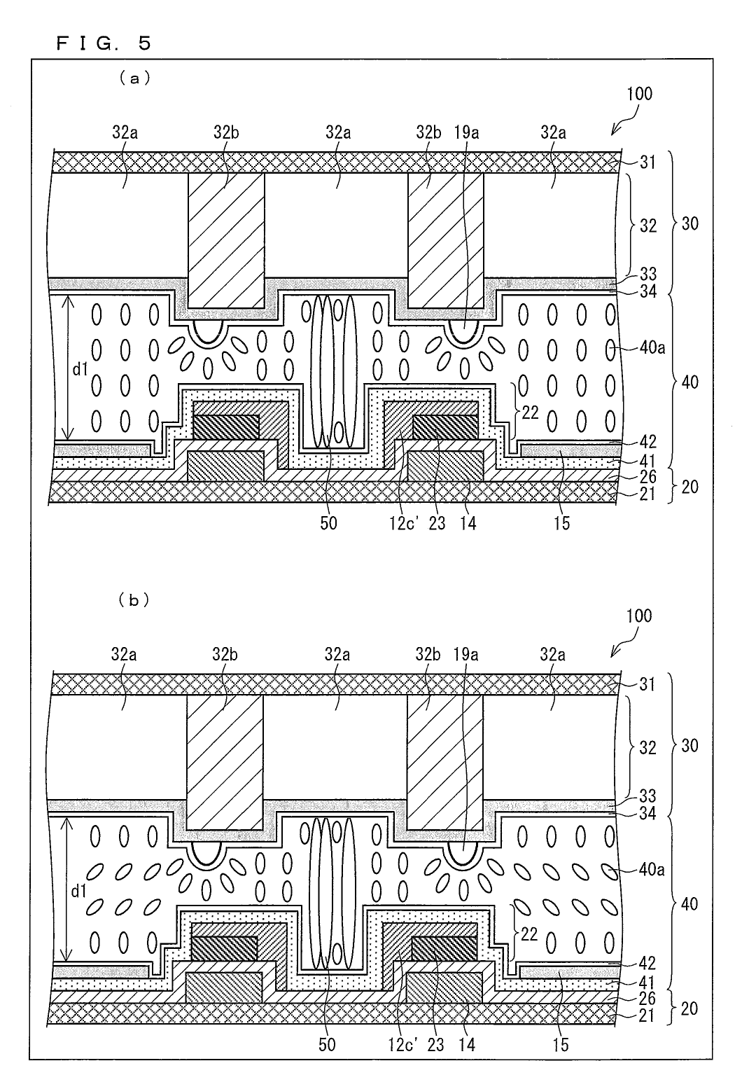

In this regard, the following describes with reference to FIG. 5. (a) of FIG. 5 illustrates how liquid crystal molecules 40a are aligned in the liquid crystal panel 100 of FIG. 3 while no voltage is applied. (b) of FIG. 5 illustrates how the liquid crystal molecules 40a are aligned in the liquid crystal panel 100 of FIG. 3 while a voltage being applied.

As shown in (a) of FIG. 5, the liquid crystal molecules 40a are aligned perpendicular to a substrate both in display regions (the regions in which the pixel electrodes 15 are disposed) and in non-display regions (regions in which the CS wires are disposed), while no voltage is applied (that is, while the liquid crystal panel is in a black display state).

In contrast, as shown in (b) of FIG. 5, the liquid crystal molecules 40a slant in the display regions (the regions in which the pixel electrodes 15 are disposed), while a voltage is being applied. This causes an increase in transmittance of the liquid crystal display. As a result, the liquid crystal panel is in a white display state. However, even while the voltage is being applied, the liquid crystal molecules 40a are still aligned perpendicular to the substrate in the regions in which the CS wires are disposed, and the liquid crystal panel is therefore still in the black display state. This is because substantially no electric potential difference is generated between the counter electrode and respective of the pixel electrodes, in the regions in which the CS wires are disposed.

In the regions in which the CS wires are provided, the liquid crystal molecules 40a are thus always aligned perpendicular to the substrate, and the liquid crystal panel is therefore always in the black display state regardless of whether no voltage is applied (see (a) of FIG. 5) or a voltage is applied (see (b) of FIG. 5). As such, according to the liquid crystal panel 100 shown in FIG. 3, no source metal layer 12c′ is provided in the regions in which the spacer particles 50 are disposed. This allows the projecting walls 22 to have a higher height.

Note that the present invention does not always require the auxiliary ribs 19a as illustrated in FIG. 3. However, it is preferable to provide the auxiliary ribs 19a because it is possible to more surely prevent the spacer particles 50 from moving into their display regions. Note also that the auxiliary ribs 19a are also applicable, for example, to the liquid crystal display device in which the spacer particles are disposed on the gate wires, as described in Embodiment 1.

It is also possible to further provide, on the TFT substrate 20, source metal layers 12c′ in regions corresponding to the regions where the colored layers 32a of the non-display region are provided. This makes it possible to more surely prevent light from being leaked from the regions in which the CS wires 14 are provided.

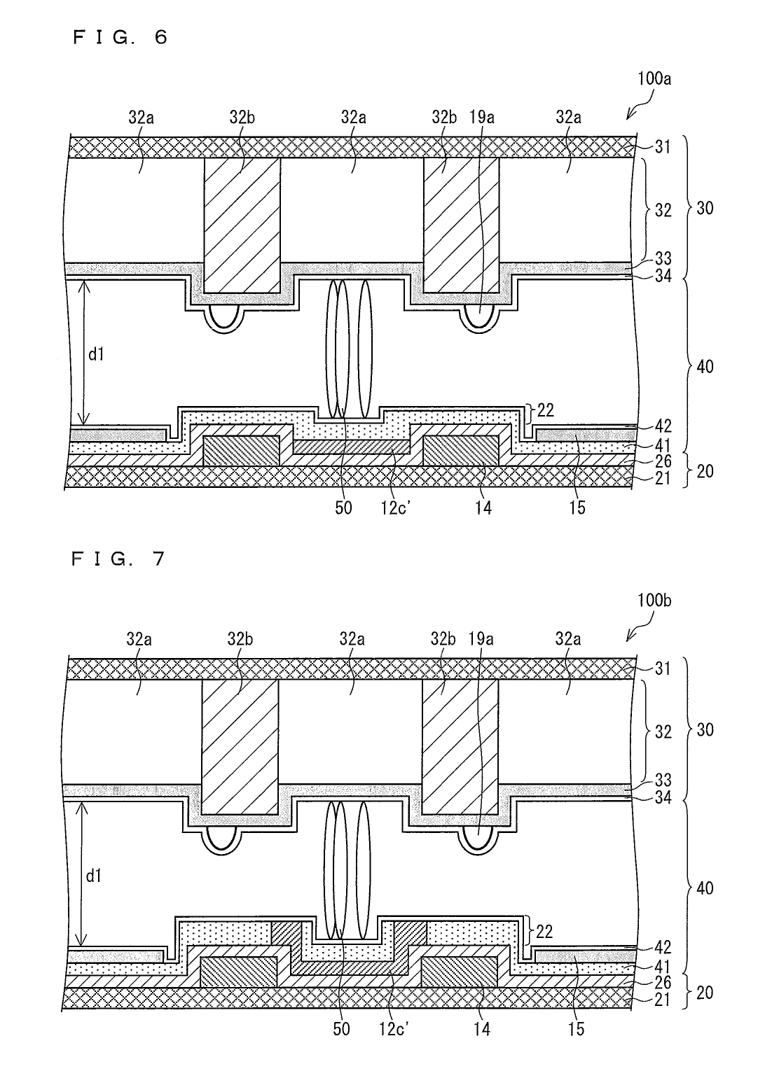

FIGS. 6 and 7 show examples of such an arrangement. According to a liquid crystal panel 100a shown in FIG. 6, each source metal layer 12c′ is provided only between corresponding CS wires 14 that are bifurcated. According to a liquid crystal panel 100b shown in FIG. 7, each source metal layer 12c′ is partially stacked on corresponding CS wires 14. In a case where each source metal layer 12c′ is thus partially stacked on corresponding CS wires, it is possible to further prevent the light from being leaked from the regions in which the CS wires 14 are provided.

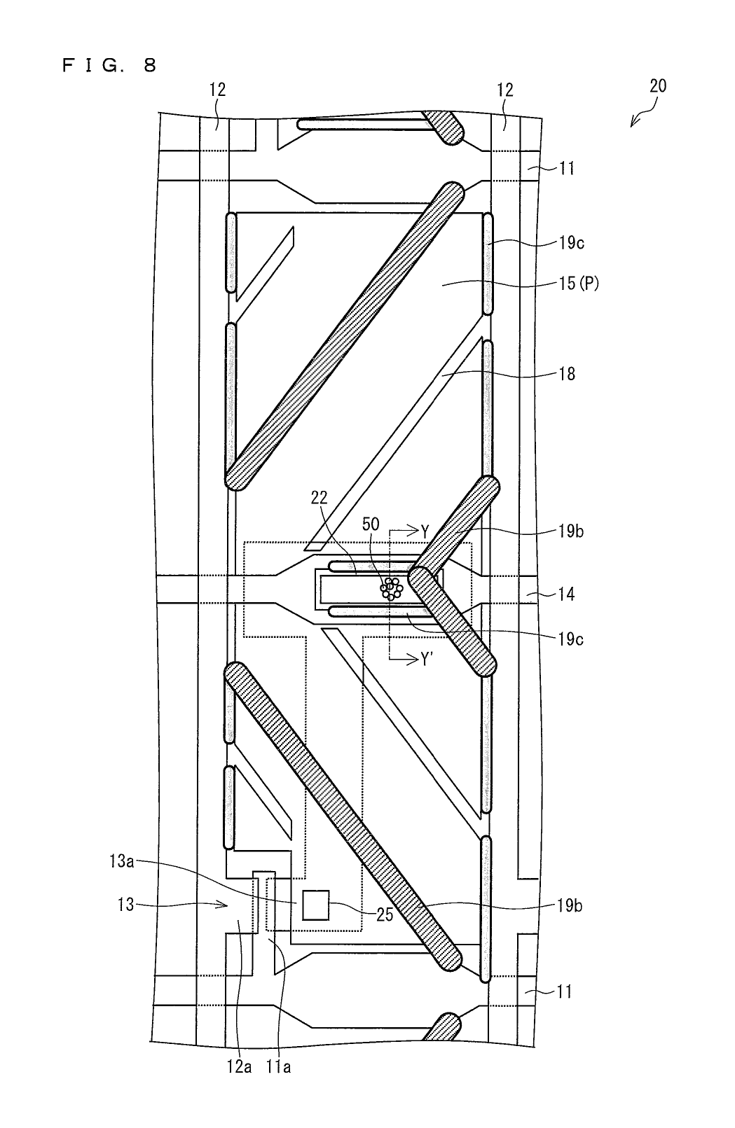

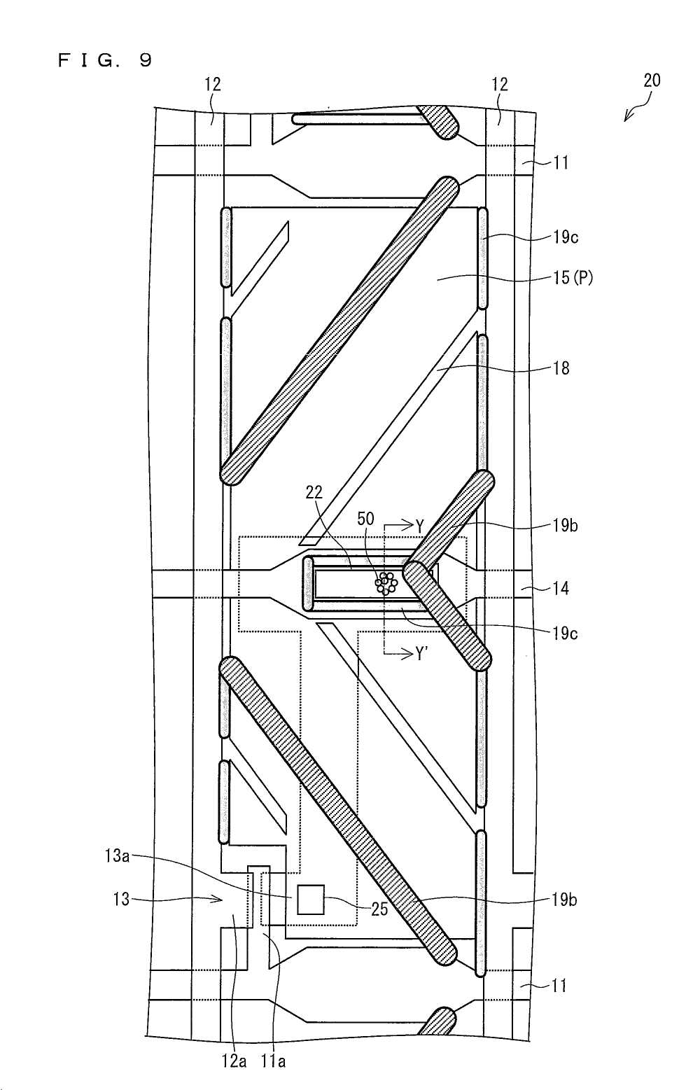

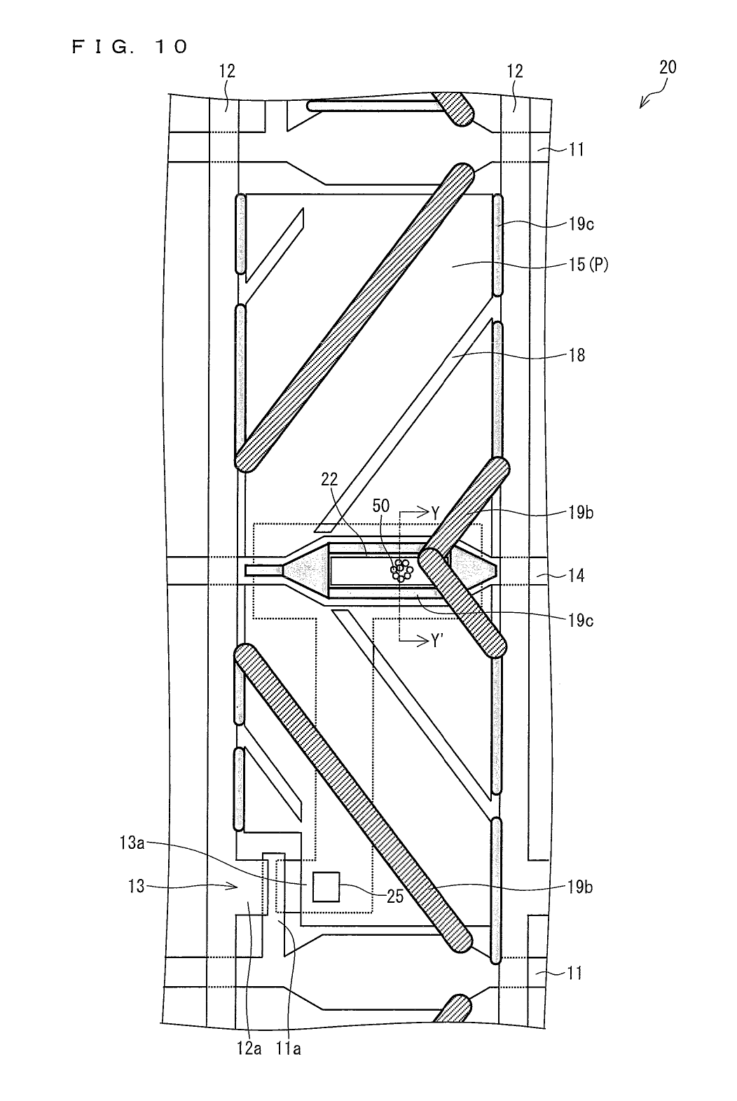

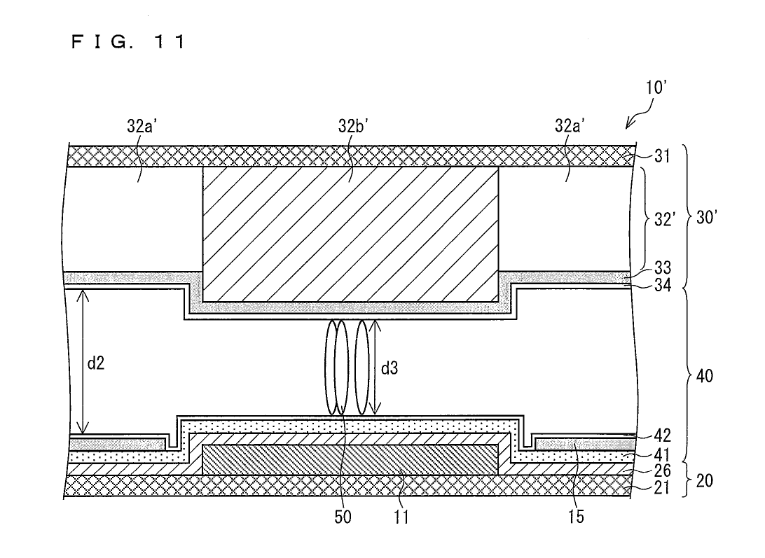

FIGS. 8 to 10 illustrate other examples of how ribs 19b and auxiliary ribs 19c are arranged on a TFT substrate. In FIGS. 8 to 10, the ribs 19b are shaded with diagonal lines, whereas the auxiliary ribs 19c are shaded with halftone. In FIG. 9, auxiliary ribs 19c are provided so as to face the projecting walls 22 disposed in a rectangular frame manner. This causes the spacer particles 50 to be further fixed. Thereby, spacer particles 50 are surrounded by the ribs 19b and the auxiliary ribs 19c. In FIG. 10, auxiliary ribs 19c are provided so as to match a shape of individual CS wires 14. This causes spacer particles 50 to be more surely fixed.

FIGS. 8 to 10 exemplify examples in which the spacer particles are disposed on the CS wires. Alternatively, it is possible to provide auxiliary ribs in a case where the spacer particles are disposed on the gate wires.

The invention is not limited to the description of the embodiments above, but may be altered within the scope of the claims. An embodiment based on a proper combination of technical means disclosed in different embodiments is encompassed in the technical scope of the invention.

Other alternative embodiments of the present invention may be variously devised without departing from aforementioned main features of the invention. Therefore, the aforementioned embodiments are intended to be merely illustrative in all respects but not restrictive. The scope of the invention is defined by the appended claims but not bound in any way by the foregoing description of this Specification. Further, it is intended that the invention be construed as including all alterations, modifications, and processes in so far as they come within the scope of the equivalents of the appended claims.

### INDUSTRIAL APPLICABILITY

The present invention is applicable to a liquid crystal display device in which spacer particles keep a gap between a pair of substrates between which a liquid crystal is filled.

1. A liquid crystal display device comprising a liquid crystal panel which includes: a color filter substrate; an element substrate; and a liquid crystal layer provided between the color filter substrate and the element substrate,
spacer particles for keeping the gap between the color filter substrate and the element substrate being disposed in regions of the liquid crystal layer which correspond to respective non-display regions of the liquid crystal panel, and
layers being provided in regions of the color filter, the regions corresponding to the respective non-display regions in which the spacer particles are disposed, the layers having a thickness equal to that of colored layers provided in regions corresponding to respective display regions.

2. The liquid crystal display device according to claim 1, wherein the layers having the thickness equal to that of the colored layers are respective colored layers.

3. The liquid crystal display device according to claim 2, wherein light shielding layers provided on the element substrate so that the light shielding layers and the colored layers provided in the respective non-display regions of the color filter substrate overlap each other.

4. The liquid crystal display device according to claim 3, wherein:
data wires, scanning wires, auxiliary capacitor wires, and switching elements are patterned on the element substrate, and
the spacer particles are disposed on the auxiliary capacitor wires.

5. The liquid crystal display device according to claim 3, wherein:
data wires, scanning wires, and switching elements are patterned on the element substrate, and
the spacer particles are disposed on the scanning wires.

6. The liquid crystal display device according to claim 1, wherein the element substrate has projecting walls, by which the spacer particles are surrounded, provided in the regions of the element substrate which correspond to the respective non-display regions of the liquid crystal panel.

7. The liquid crystal display device according to claim 1, wherein the color filter substrate has projecting walls, by which the spacer particles are surrounded, provided in the regions of the color filter substrate which correspond to the respective non-display regions of the liquid crystal panel.

8. The liquid crystal display device according to claim 2, wherein:
the color filter substrate has black matrices provided in regions corresponding to non-display regions in which no spacer particle is disposed, and
the black matrices are larger in thickness than the colored layers.

9. A method for manufacturing a liquid crystal display device recited in claim 2,
the method comprising the step of:
concurrently forming the colored layers of the display regions and the colored layers of the non-display regions in a single manufacturing step.
